(19) United States
(12) Patent Application Publication
(10) Pub. No.: US 2026/0356647 A1
(43) Pub. Date: Nov. 12, 2026

(54) AUTOMATIC FLIP-TOP CAP CLOSING MACHINE

(71) Applicant: PLENMA Company Limited, Ho Chi Minh City (VN)

(72) Inventor: Dang Le Nhat LINH, Ho Chi Minh City (VN)

(21) Appl. No.: 19/727,327

(22) Filed: Jul. 1, 2026

(30) Foreign Application Priority Data
Jul. 4, 2025 (VN) 1202504735

(51) Int. Cl. B67B 3/20

(52) U.S. Cl. CPC B67B 3/2066

(57) ABSTRACT

An automatic cap flipping and closing system for bottles (1000) including a cap suction arm (100) movable between an injection moulding machine (500) and a Cap-Flipping and Cap-Closing Assembly (200); a main frame (250) for securing the positions of the Cap-Holding and Flip Assembly (210); a Cap-Closing and Cap-Suction Assembly (220); a chute (230); a control system (240); the main frame (250) having wheels and feet for securing its working position.

### FIELD OF THE INVENTION

The present invention relates to an automated system for flipping and closing bottle caps. Specifically, it relates to plastic caps having a flip-top closure that are injection-moulded and used to seal plastic bottles. These plastic caps are in an open state after moulding and must therefore have their flip-top closed before being fitted onto the plastic bottles.

### STATE OF THE ART

An automatic device for closing injection-moulded bottle caps from an injection moulding machine comprises a loading mechanism including a vibration plate for screening materials and a standby mechanism connected to the vibration plate for temporarily storing bottle caps; a pick-and-place mechanism provided with a gripping component and a suction component for gripping caps on the standby mechanism and for absorbing and discharging injection-moulded products; and a waste-holding mechanism for retaining waste generated during the injection moulding of bottle caps. The standby mechanism comprises a feed channel, a top material assembly, a first detection fibre, and a second detection fibre. The feed channel communicates with the outlet of the vibration plate and is used to transport bottle caps. The top material assembly is disposed beneath the feed channel to insert caps into the feed rod. The first optical detection fibre is disposed on the feed channel to detect the presence of caps thereon, and the second detection light is disposed beside the push assembly to detect whether a bottle cap has been elevated. The feed channel comprises a slide, an adjustment plate disposed on both lateral sides of the slide, and a pillar plate disposed at the terminal end of the slide; both the adjustment plate and the pillar plate are detachably and fixedly connected to the slide. The adjustment plate and the pillar plate are each provided with a waist-shaped elongated slot. The adjustment plate and the pillar plate are secured to the pillar plate through the waist-shaped slots by means of bolts. The longitudinal direction of the waist-shaped slot on the adjustment plate is perpendicular to the longitudinal direction of the slide, enabling the distance between the two adjustment plates to be adjusted to accommodate inserts of different widths. The waist-shaped slot relative to the plate conforms to the longitudinal direction of the slide, enabling accommodation of caps of different dimensions after completion for transfer to an assembly line for collection. However, this device presents several unresolved technical drawbacks: complex design with numerous mechanical components requiring frequent maintenance, and difficulty handling products of different shapes or dimensions.

A linear filling and capping machine, characterised in that the linear filling and capping machine comprises a frame, a conveyor, a cup-sorting and feeding mechanism, a cup-rotating clamp component, a filling device, a film-suction device, a heat-sealing device, a lid-sorting and fitting mechanism, a cup-locking device, and a cup pick-and-place component mounted on a support rack with a conveyor for cup feeding. The left-side input of the conveyor is connected to the cup-sorting mechanism for proper cup arrangement. The rotating cup-clamp component feeds cups sequentially onto the conveyor. The filling device, film-suction device, heat-sealing device, and cup-locking device are arranged on the support rack along the conveying direction. The rear of the cup-locking device is connected to the lid-sorting mechanism, and the right-side output of the conveyor is connected to the cup pick-and-place component. This device presents difficulties in maintaining accuracy and synchronisation at high operating speeds, and an elevated risk of equipment failure or product defects due to high operational velocity.

An automatic rotary bottle-capping device comprises a cap-feeding mechanism using a conveyor to deliver caps to the capping station, a cap-tightening mechanism comprising a capping head with a rotary tightening mechanism to ensure caps are firmly screwed onto bottles, and an integrated control system for adjusting capping torque and speed. This device presents unresolved technical problems including difficulty adjusting torque to accommodate different cap and bottle types, and the absence of automatic fault-detection and fault-handling capability during the capping process.

### TECHNICAL NATURE OF THE INVENTION

The object of the present invention is to propose an Automatic Flip-top Cap Closing Machine (1000) capable of overcoming the technical problems remaining in the prior art. Specifically, the system aims to fully automate the post-injection-moulding plastic cap handling process, comprising: flipping the flip-top portion of the cap to a semi-closed state; closing the flip-top to achieve a fully locked/closed state; and gripping and transferring the finished caps to the finished-product storage module.

The overall system structure comprises three main modules in the cap-closing system: Module A performs the flip and press function for the flip-top; Module B awaits receipt of caps and releases caps after closing; Module C has a chute (230) for retaining finished caps.

The main functional assemblies comprise: cap suction arm (100) for retrieving caps from the injection mould (500); Cap-Holding and Flip Assembly (210) (fixed at Module A); Cap-Closing and Cap-Suction Assembly (220) (mobile between Modules A and B).

The operating principle of the three main modules is set out as follows:

Module 1—Cap Flipping. The purpose is to flip the flip-top from the open state to the semi-closed state. Sequence of operations: The cap suction arm (100) uses suction cups (140) to retrieve caps from the injection mould (500) and releases them into the cap fixture at Module A. A sensor confirms cap presence, after which the cap-holding cylinder is actuated, closing the clamping plate down to hold the cap firmly in place. The flip cylinder moves upward and sweeps laterally, using the flip plate to push the flip-top upward lightly against the cap base. Bottle cap (10) transitions from the open state to the semi-closed state.

Module 2—Cap Closing. The function is to firmly press the semi-closed flip-top to complete the cap. Sequence of operations: The closing and suction assembly (with linear slide and pneumatic cylinder) moves from Module B to Module A, positioning the closing heads concentrically with the cap fixture. The closing cylinder drives the closing heads downward, comsealing the flip-top firmly against the cap base.

Module 3—Suction and Release of Finished Caps. The function is to grip pressed caps from the fixture and transfer them to the finished-product chute (230). Sequence of operations: after closing is complete, the closing cylinder retracts; the suction-positioning cylinder then adjusts the suction disc (with suction cups 140) to align concentrically with the cap positions. Suction cups (140) descend to suction-grip the caps from the fixture, then retract upward. The Cap-Closing and Cap-Suction Assembly moves from A to B, then releases the caps into the finished-product collection chute (230).

### ADVANTAGES OF THE INVENTION

Full automation from cap retrieval from the mould, through flipping, closing, suctioning, to cap placement. High precision owing to input-checking sensors, linear guides, and concentric alignment between assemblies. Space and cycle-time optimisation through the bidirectional traversal capability of the closing-suction assembly between two modules, with no additional external robot required.

### BRIEF DESCRIPTION OF THE DRAWINGS

FIG. 1 is a perspective view showing the automatic cap flipping and closing system for bottles;

FIG. 2 is a front elevation view showing the rear of the automatic cap flipping and closing system for bottles;

FIG. 3 is a perspective view showing the cap suction arm assembly;

FIG. 4 is a perspective view showing the cap-flipping and cap-closing assembly;

FIG. 5 is a perspective view showing the cap-flipping and cap-closing assembly with bottle caps in the open state;

FIGS. 6a and 6b are partial exploded perspective views of the cap-flipping and cap-holding mechanism of the cap-flipping and cap-closing assembly;

FIG. 7 is a perspective view showing the cap-closing and cap-suction assembly;

FIG. 8 is a perspective view showing details of the closing heads and suction heads of the cap-closing and cap-suction assembly;

FIG. 9 is a perspective view showing the cap-closing and cap-suction assembly together with the linear guidance assembly;

FIG. 10 is a perspective view showing details of the linear guidance assembly;

FIG. 11 is a perspective view showing the working position of the cap-closing and cap-suction assembly and the cap-flipping and cap-closing assembly with the bottle caps in the open state;

FIG. 12 is a side elevation view showing the relative position between a bottle cap in the open state and the cap-flipping mechanism;

FIG. 13 illustrates the step in which the cap suction arm places bottle caps in the open state onto the cap-flipping and cap-closing assembly;

FIG. 14 illustrates bottle caps in the semi-closed state after the cap-flipping step;

FIG. 15 illustrates the step in which the cap-closing and cap-suction assembly advances and presses the caps to the fully locked/closed state;

FIG. 16 illustrates the step in which the cap-closing and cap-suction assembly performs the cap-suction step and moves out of the cap-flipping and cap-closing assembly.

### DETAILED DESCRIPTION OF THE INVENTION

The present invention is described in detail with reference to the preferred embodiments illustrated in the accompanying drawings. It is to be understood that the described embodiments are provided solely for the purpose of illustrating the nature and advantages of the invention and shall not be construed as limiting the scope of the invention.

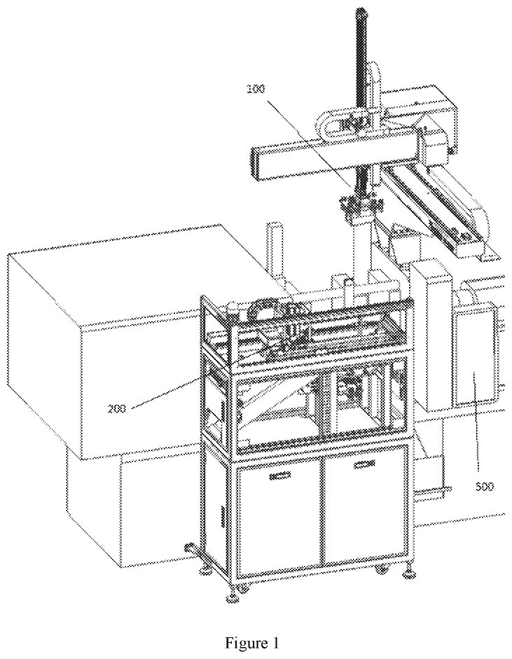

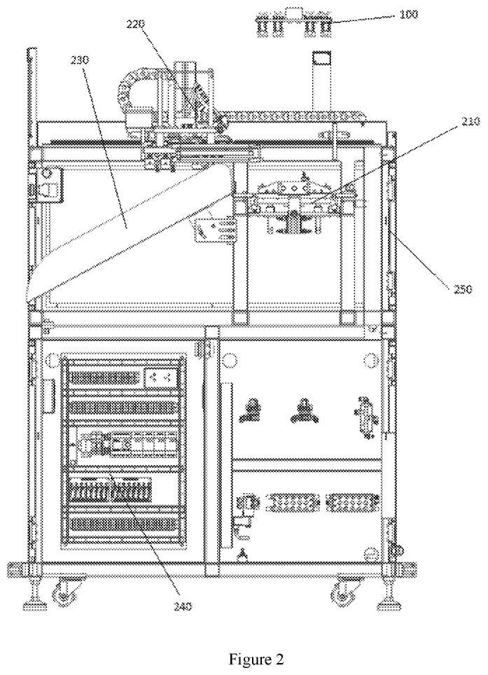

As shown in FIGS. 1 and 2, the Automatic Flip-top Cap Closing Machine comprises a cap suction arm (100) movable between the injection moulding machine (500) and the Cap-Flipping and Cap-Closing Assembly (200), a main frame (250) for securing the positions of the Cap-Holding and Flip Assembly (210), the Cap-Closing and Cap-Suction Assembly (220), the chute (230), and the control system (240). The main frame (250) further comprises wheels for flexible mobility and feet for securing its position during operation.

The cap suction arm (100) retrieves bottle caps (10) in the open state from the mould on the injection moulding machine (500). The Cap-Holding and Flip Assembly (210) receives bottle caps (10) in the open state from the cap suction arm (100). Therein, the flip-top of bottle cap (10) is flipped, transitioning from the open state to the semi-closed state, and the Cap-Closing and Cap-Suction Assembly (220) moves into position to lock the bottle cap (10) to the fully closed state.

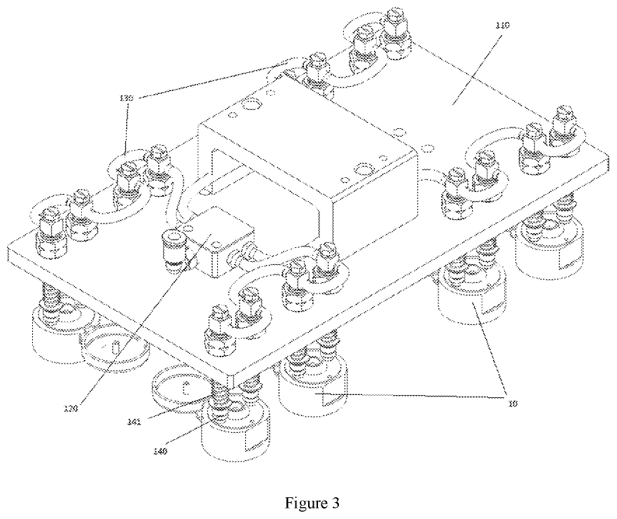

As shown in FIG. 3, the cap suction arm (100) comprises an aluminium or lightweight steel suction base (110) having a plurality of aligned apertures for arranging suction cups (140) distributed in conformity with the cap profile, arranged in pairs to suction-grip bottle caps (10) in the open state. Guide springs (141) enable the suction cups (140) to self-adjust to cap height. A solenoid valve connected to component (120) controls the suction cups (140) via pneumatic tubing (130) to suction-grip or release bottle caps (10) in response to control signals from the control system (240). The tips of the suction cups (140) are made of silicone or soft polyurethane (PU) compatible with plastic materials; the spring-loaded shock-absorbing mechanism ensures good contact with the cap surface and generates suction force sufficient to lift the cap without displacing its position. The positions of the suction cups (140) are arranged to correspond to the positions and quantity of bottle caps (10) on the injection mould. In one exemplary embodiment as shown in FIG. 3, the number of bottle caps (10) per injection shot is eight.

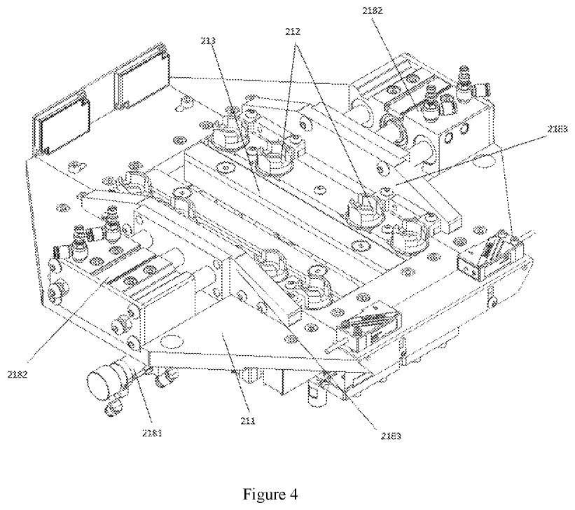

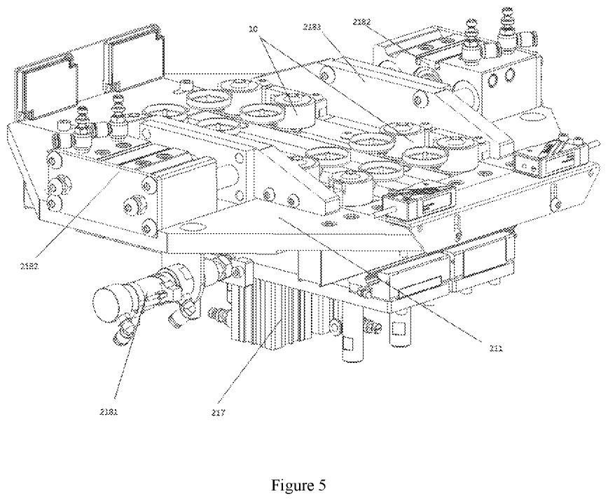

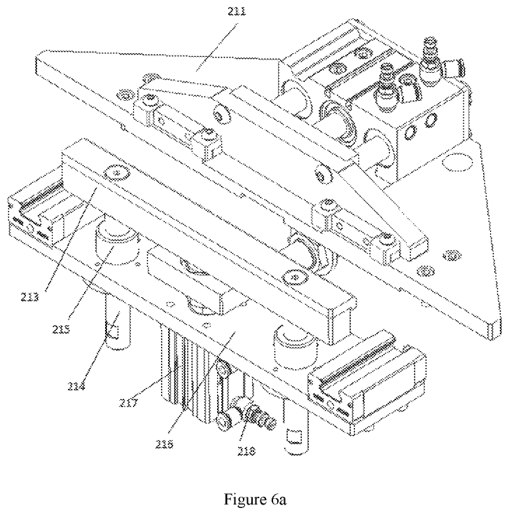

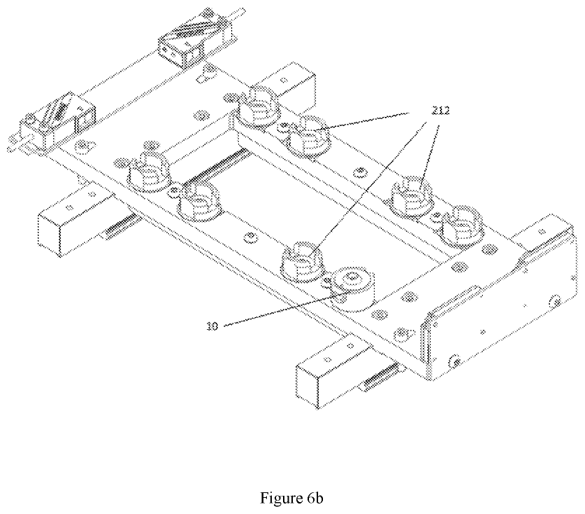

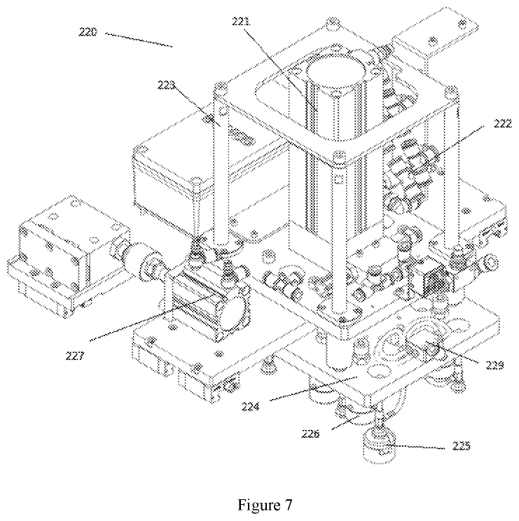

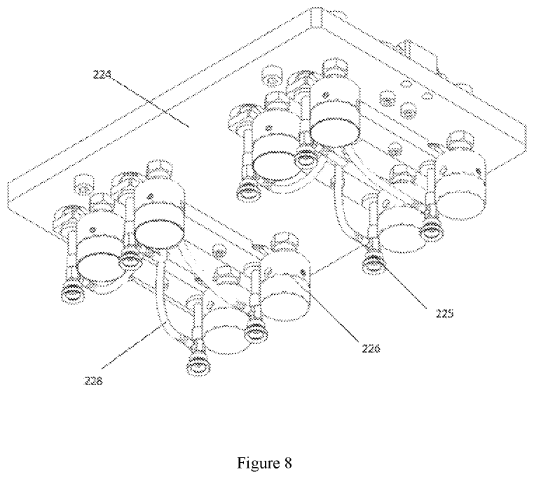

As shown in FIGS. 4 through 6b, the Cap-Holding and Flip Assembly (210) comprises a base (211), typically of solid steel or aluminium, serving as the primary load-bearing frame for mounting mechanical, pneumatic, and control components. Circular clamping pins (212) are arranged on the base (211) for precisely positioning plastic caps during closing. The positions of the clamping pins (212) correspond to the positions and quantity of bottle caps (10) on the cap suction arm (100). A sensor detects whether a cap has been correctly positioned. A holding cylinder (2182) is disposed corresponding to each row of clamping pins (212) and controls a clamping plate (2183) having holding heads corresponding to each clamping pin (212) position, so as to hold bottle caps (10) firmly and prevent them from being dislodged from the clamping pins (212) during the cap-flipping operation. Via pneumatic tubing (218), a cap-flipping cylinder (217) controls the translational upward and downward movement of the flip plate (213). Two guide shafts (214) undergo translational movement sliding within guide bushings (215) to direct the movement of the flip plate (213) and prevent rotation during the cap-flipping operation. A positioning cylinder (2181) is disposed horizontally and is configured to adjust the relative position of the entire flip plate assembly (213) sliding on the linear slide system, so as to correspond to the position and dimensions of the bottle cap (10) to be flipped.

The Cap-Closing and Cap-Suction Assembly (220) disposed above the clamping assembly comprises a base plate (224) and an upper frame (223) for arranging closing heads (226) controlled by a closing cylinder (221) capable of upward/downward pneumatic actuation, functioning to press the flip-top from the ‘semi-closed’ state to the ‘fully locked/closed’ state. A cylinder (227) connected to the linear guidance assembly moves the Cap-Closing and Cap-Suction Assembly (220) inward or outward in response to control signals. A solenoid valve connected to component (229) controls the suction or release force of the suction heads (225) via pneumatic tubing (228). The Cap-Closing and Cap-Suction Assembly (220) further incorporates stroke sensors and pressure sensors for detecting cap drops during the suction process. Upon detection of any dropped cap, the pressure sensor signals the controller to trigger a cap-drop fault alert on the HMI screen.

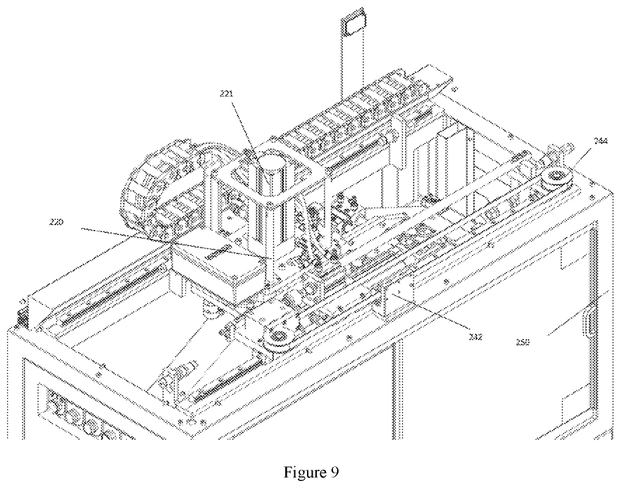

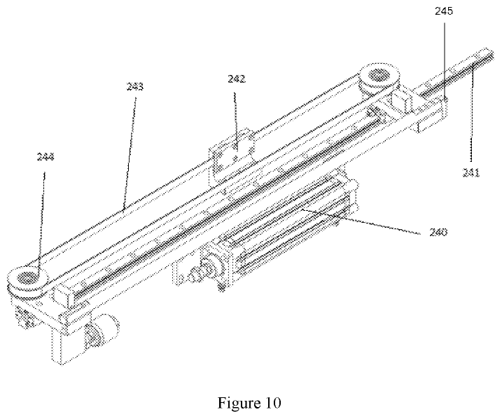

As shown in FIGS. 9 and 10, the linear guidance assembly comprises pulleys (244) for transmitting movement to the belt (243). A guide plate (242) stabilises belt (243) movement. A linear rail (241) provides smooth and precise linear motion for the machine. A pillow block (245) is provided for adjusting the relative position between the two pulleys (244) when the belt (243) becomes slack after extended operation. A pneumatic cylinder (240) actuates movement of the Cap-Closing and Cap-Suction Assembly (220) to press and suction finished caps for release into the chute (230).

The linear guidance assembly is responsible for transferring the closing assembly from the cap release position to the closing position and vice versa. A vacuum suction head assembly is mounted on the closing disc or a separate mobile assembly. After closing is complete, the suction disc descends to suction-grip the caps and transfers them to the release position. A flexible suction tube connected to a suction pump or solenoid-controlled valve may be integrated.

The sensor assembly comprises optical sensors for detecting the presence or absence of caps in the fixture; stroke sensors for checking the position of closing heads, the position of the suction disc, and pneumatic status. These sensors are mounted at stroke ends, linear slides, and the suction assembly.

Pneumatic valves and pneumatic connectors are mounted at the top of the circular blocks, comprising solenoid valves controlling the actuation direction of the closing/suction cylinders, and may include quick-connect fittings and air filters.

The force and stroke adjustment assembly may comprise adjustment screws for closing force, stroke, or cap fixture position, enabling fine-tuning for different cap types.

The lift-press-suction mechanism assembly in the automatic cap-closing machine system integrates pneumatic cylinders, a vacuum suction system, and a control module.

A vertical pneumatic cylinder at the centre position has a large upward/downward stroke. The function of this pneumatic cylinder is to press the flip-top in the cap-closing module or to raise and lower the finished-cap suction assembly. The cylinder is fixedly mounted to the support frame by means of bolts. A reinforced structural frame made of profiled steel or aluminium serves to secure the cylinders, solenoid valve assembly, and sensor units, providing rigidity to prevent axis misalignment during closing. The pneumatic control assembly is disposed on the right side and comprises four or five solenoid valves. Each valve independently controls one cylinder or one suction mechanism and is connected to the pneumatic supply and electrical signals from the controller (PLC). LED indicators show the on/off status of each valve.

The pneumatic tubing system uses blue tubing for pressurised air supply and yellow tubing for sensor signals or solenoid valve control, connecting from the pneumatic valves to cylinders, suction assemblies, and other pneumatic devices.

The horizontal push cylinder assembly is disposed on the left side and is of a double-ended cylinder configuration. It functions to move the cap fixture assembly or suction assembly in the horizontal direction, enabling lateral displacement from the closing position to the release position.

The cap-gripping or cap-suction assembly is disposed beneath the lifting platform, with the lower portion comprising the vacuum suction cup (140) assembly or the pneumatic gripping assembly. The cap-gripping or cap-suction assembly is controlled by a vacuum pump/valve suction system or integrated cylinders for opening/closing the clamping mechanism.

Proximity and stroke sensors mounted on the main cylinder frame and the lower linear slide assembly serve to determine the position of the closing assembly (up/down) and to verify correct cap suctioning.

The vibration-damping and anti-vibration base assembly comprises four circular-shaped machine feet with spring or rubber dampers, reducing vibration during high-force closing and enhancing stability during continuous operation. The electrical control cabinet disposed adjacent to the pneumatic valve assembly serves as the sensor controller or PLC signal junction.

The function of this assembly is to constitute the core component of the flip-top closing stage or finished-product suction stage in the cap-closing machine line. The coordinated operation of the vertical cylinders, horizontal cylinders, vacuum suction system, sensors, and pneumatic valves enables this assembly to fully automate the following operations: raising and lowering the closing head assembly; lateral movement for cap gripping/releasing; automatic inspection; and connection to the central control system (240) (PLC).

The cap-gripping and releasing assembly using a vacuum suction mechanism in the automatic cap-feeding system for the cap-removal/cap-closing machine. The following is a detailed description of each major component.

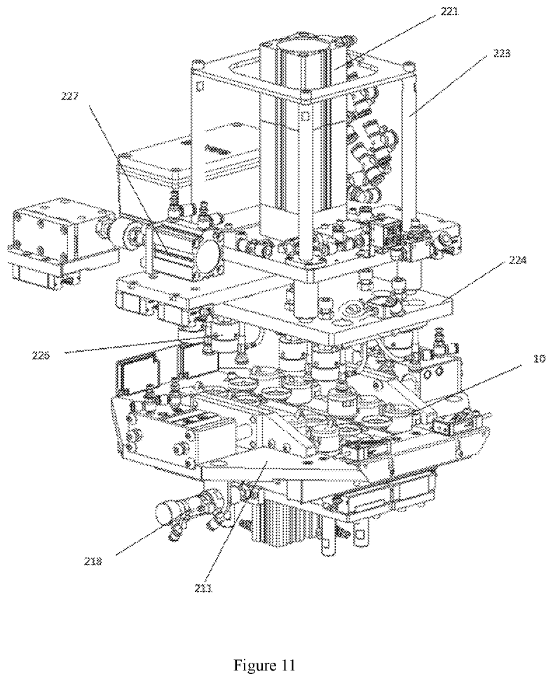

FIGS. 11 through 16 illustrate the operating sequence of the automatic cap flipping and closing system for bottles, wherein FIG. 11 is a perspective view showing the working position of the cap-closing and cap-suction assembly and the cap-flipping and cap-closing assembly with the bottle caps in the open state;

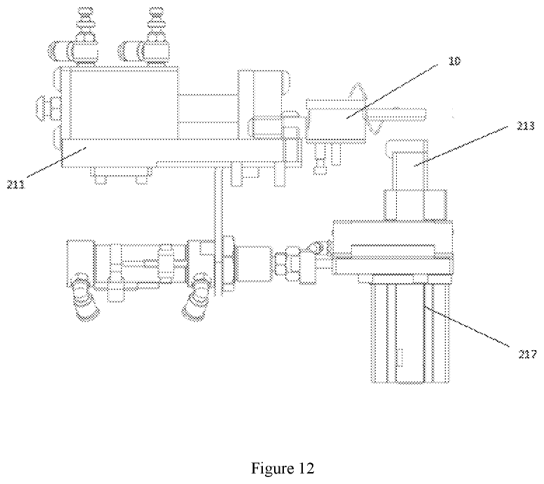

FIG. 12 is a side elevation view showing the relative position between a bottle cap in the open state and the cap-flipping mechanism;

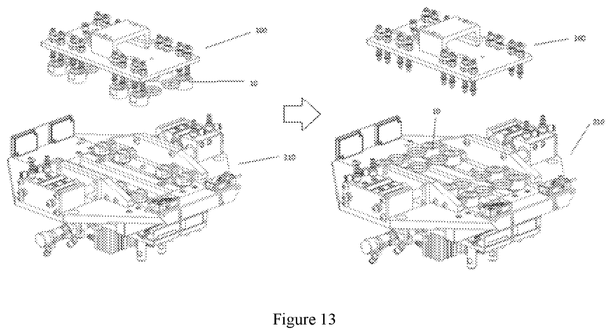

FIG. 13 illustrates the step in which the cap suction arm places bottle caps in the open state onto the cap-flipping and cap-closing assembly;

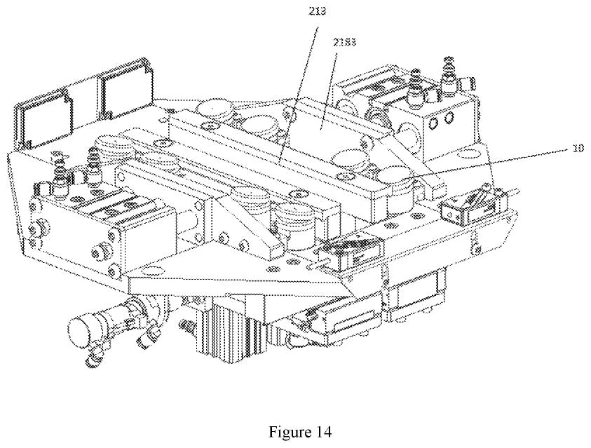

FIG. 14 illustrates bottle caps in the semi-closed state after the cap-flipping step;

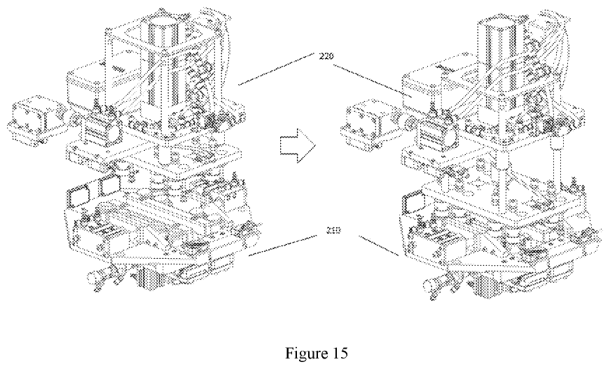

FIG. 15 illustrates the step in which the cap-closing and cap-suction assembly advances and presses the caps to the fully locked/closed state;

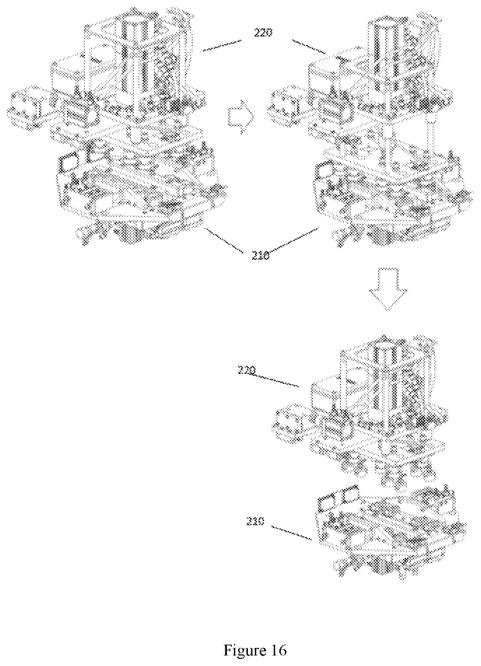

FIG. 16 illustrates the step in which the cap-closing and cap-suction assembly performs the cap-suction step and moves out of the cap-flipping and cap-closing assembly.

The injection moulding machine for cap supply is not shown in full, but this is the module where caps are injection-moulded and awaiting retrieval. The cap suction arm moves to this location to retrieve plastic caps in the open state (flip-top not yet pressed). The cap fixture—the cap-release position for closing—is a mechanical fixture assembly mounted on the cap-closing machine, having multiple recesses corresponding to the cap dimensions for individually positioning each cap for transfer to the flip-top closing module or subsequent processing. Caps may be clamped by pneumatic actuation or spring mechanism. The operating sequence comprises: Step 1—the cap suction arm descends and releases caps into the corresponding positions of the cap fixture. Step 2—after release, the cap suction arm ascends and returns to the injection moulding machine module (500) to retrieve the next batch of caps. In conjunction with the control system (240), the cap suction arm is mounted on a pneumatic cylinder or linear axis for upward/downward and lateral movement. The central controller (PLC) synchronises signals with the injection moulding machine (500) to determine when caps are ready. It controls the vacuum valve for cap suctioning/releasing, and performs inspection by means of sensors; the suction cups (140) may be equipped with pressure sensors or proximity sensors.

The cap support and automatic cap-closing fixture assembly, upon receipt of caps from the cap suction arm (100), comprises sensors mounted at various positions throughout the fixture assembly. Magnetic proximity sensors, optical sensors, or contact sensors are commonly used. These sensors function to detect the presence or absence of caps at the cap-removal position, to verify the stroke position of pneumatic cylinders, and to transmit signals to the PLC to control subsequent process steps (cap-closing, cap-flipping, cap-holding, etc.).

The cap-holding cylinder assembly comprises a double-acting pneumatic cylinder and a guide mount. The cylinder head contacts the cap body to hold the cap firmly in place during the cap-flipping operation, performing clamping or open/close actuation. The cap-holding cylinder assembly ensures that the cap does not shift throughout the entire operation. The cap clamping plate is a flat closing block positioned above the cap assembly, acting from above to fix the cap face and secure the cap firmly during flip-top flipping or adhesive closing. It may be actuated by a pneumatic cylinder or elastic spring.

Each set of caps may be processed simultaneously in the horizontal row. All mechanisms are mounted on a single primary mechanical frame, beneath which the pneumatic system, electrical wiring, and sensors are connected to the central PLC controller.

Operating sequence from cap receipt to cap-removal/opening completion: The cap suction arm (100) releases caps into the fixture assembly. Sensors detect cap presence and transmit a signal. The cap-holding cylinder is actuated and clamps the cap body. The clamping plate presses down to fix the top face of the cap. The flip cylinder is actuated, rotating the flip plate to open the flip-top. After flipping is complete, all mechanisms retract, awaiting the next cycle or transitioning to the closing step.

The flip-top closing head assembly—the next stage in the cap—removal and automatic cap-closing process chain. The following is a detailed description of the construction and function of each component:

Construction of the flip-top closing head assembly (after cap opening) comprises: a flip-top closing cylinder—a large vertically actuated pneumatic cylinder-generating downward force on the closing head to press the flip-top firmly against the cap body, fixedly mounted above the main frame. A suction-positioning cylinder (horizontal cylinder or guided slide mechanism) functions to move the suction cup (140) assembly out of the working zone before flip-top closing, ensuring no collision between the closing head and suction cups (140). The closing head is the central component of the closing system—connected to the output of the closing cylinder—machined to the exact profile of the flip-top. Its function is to press the flip-top, which has been flipped/opened, to the adhesively bonded or locked state against the cap body. The lower portion of the closing head is precisely aligned concentrically with the centreline of the cap-removal fixture to ensure concentricity. The suction cup assembly comprises multiple small vacuum suction cups, initially used to hold the flip-top or to precisely position the cap during assembly. After positioning is complete, the suction cups are retracted laterally by the cylinder to make way for the closing head.

General operating sequence: The flip cylinder has previously performed the cap-flipping operation. The suction-positioning cylinder retracts the suction cups (140) out of the central zone. The flip-top closing cylinder is actuated, driving the closing head downward. The closing head presses the flip-top firmly against the cap body. After completion, the closing head retracts upward, ready for output of the fully pressed cap.

The purpose of the system is to ensure a fully automated cap closure/flip-top closing operation after the flip-top has been opened. High precision in terms of position, closing force, and speed is ensured to prevent cap fracture or positional misalignment.

Detailed construction and function of each component in this assembly—the final stage of the cap-closing cycle—comprises the following: Flip-top closing cylinder (retracted): after completing the closing operation, this pneumatic cylinder retracts upward, removing the closing head from the cap and restoring the working space for the gripping component or the next stage of the production line. Suction-positioning cylinder (retracted): retracts the suction cup (140) assembly back to its original central position, enabling continuation of the cycle for gripping new caps. This action occurs after the closing head has fully retracted to avoid collision. The suction cup assembly—comprising multiple small vacuum cups precisely positioned at the centreline of the cap fixture—is ready upon return to the central position to suction-grip new caps from the injection mould. The pressed cap: at this stage the cap has been fully closed with the flip-top secured and fixed in the completed state.

The entire process performed comprises: gripping caps from the injection moulding machine (500); releasing into the cap fixture; flipping open the flip-top; closing the flip-top back and securing it with the closing head; completing the cycle and preparing for product removal or packaging.

The cap fixture—the central operating platform—serves as the primary base for positioning caps throughout the entire flip-press process, comprising clamping and positioning mechanisms, guides, and inspection sensors.

1. An automatic cap flipping and closing system for bottles (1000), comprising:
a cap suction arm (100) movable between an injection moulding machine (500) and a cap-flipping and cap-closing assembly (200);
a main frame (250) for securing the positions of the cap-holding and flip assembly (210);
a cap-closing and cap-suction assembly (220);
a chute (230);
a control system (240);
wherein the main frame (250) includes wheels and feet for securing its working position;
wherein the cap suction arm (100) includes an aluminium suction base (110) having:
a plurality of aligned apertures for arranging suction cups (140) distributed in conformity with the cap profile, arranged in pairs to suction-grip bottle caps (10) in the open state;
guide springs (141) enabling the suction cups (140) to self-adjust to cap height;
a solenoid valve (120) controlling the suction cups (140) via pneumatic tubing (130) to suction-grip or release bottle caps (10) in response to control signals from the control system (240);
the tips of the suction cups (140) being made of silicone;
the cap-holding and flip assembly (210) including:
a base (211);
circular clamping pins (212) arranged on the base (211) for precisely positioning plastic caps during closing;
a sensor for detecting whether a cap has been correctly positioned;
a holding cylinder (2182) disposed corresponding to each row of clamping pins (212) for controlling a clamping plate (2183) having holding heads corresponding to each clamping pin (212) position, so as to hold bottle caps (10) firmly and prevent them from being dislodged from the clamping pins (212) during the cap-flipping operation;
pneumatic tubing (218);
a cap-flipping cylinder (217) for controlling the translational upward and downward movement of the flip plate (213);
at least two guide shafts (214) undergoing translational movement sliding within guide bushings (215) to direct the movement of the flip plate (213) and prevent rotation during the cap-flipping operation;
a positioning cylinder (2181) disposed horizontally and configured to adjust the relative position of the entire flip plate assembly (213) sliding on the linear slide system, so as to correspond to the position and dimensions of the bottle cap (10) to be flipped;
the cap-closing and cap-suction assembly (220) being disposed above the clamping assembly having a base plate (224) and an upper frame (223) for arranging closing heads (226) controlled by a closing cylinder (221) capable of upward/downward pneumatic actuation;
a cylinder (227) connected to the linear guidance assembly for moving the cap-closing and cap-suction assembly (220) inward or outward in response to control signals;
a solenoid valve connected to component (229) for controlling the suction or release force of the suction heads (225) via pneumatic tubing (228);
the cap-closing and cap-suction assembly (220) further incorporating stroke sensors and pressure sensors for detecting cap drops during the suction process;
the linear guidance assembly comprising:
pulleys (244) for transmitting movement to the belt (243); a guide plate (242) for stabilising belt (243) movement;
a pillow block (245) for adjusting the relative position between the two pulleys (244) when the belt (243) becomes slack after extended operation; and
a pneumatic cylinder (240) for actuating movement of the cap-closing and cap-suction assembly (220) to press and suction finished caps for release into the chute (230).
